(19) United States
(12) Patent Application Publication
(10) Pub. No.: US 2003/0065545 A1
(43) Pub. Date: Apr. 3, 2003

(54) Appointment system for new home buyers

(76) Inventor: Barry Lynn, Hollywood, FL (US)

Correspondence Address: David W. Barman, 1101 NE 176 Terrace, North Miami Beach, FL, 33162, US

(21) Appl. No.: 09/968,070

(22) Filed: Oct. 1, 2001

(51) Int. Cl. G06F 17/60

(52) U.S. Cl. 705/8

(57) ABSTRACT

A system and method by which a consumer can view web based information through a central service and set specific appointments with a selection of various builders and/or new home communities site is disclosed and described.

### FIELD OF THE INVENTION

The present invention relates to a system and method by which a consumer can view web based information through a central service and set specific appointments with a selection of various home builders through one central site.

### BACKGROUND OF THE INVENTION

The World Wide Web (WWW) has created numerous opportunities for the way business is conducted. The currently available computer technology has provided for us a virtual global marketplace. At this time, a consumer can buy almost anything on-line. Still, there are certain purchases that are of such paramount importance, that a virtual shopper still is uneasy about making. One such area is that of home buying.

The WWW provides a plethora of information regarding the process of home buying. Still, a purchase of this magnitude and importance still requires a purchaser to personally view property and decide if this is the desired property. Even a virtual and computer savvy prospective homebuyer wants the process done with ease. The level of ease is even more important for the people who are not as proficient with the WWW and computer technology.

Many homebuilders have web sites and information available on the internet. Currently a consumer must navigate each individual site, and determine if they wish to physically visit the properties displayed. Many of them contain a link, or a way to electronically ask for more information. Very few, allow the buyer to set an appointment at that moment.

The technology for electronic calanders and scheduling is well known in the art. U.S. Pat. No. 6,278,456 incorporated herein by reference is one such example of a web-based calander. While this patent describes the process of using a web based calendar for the scheduling of events and the receiving of electronic confirmation, it does not allow for many of the features that are part of the novelty of the current invention.

It is an object of the current invention to provide for a consumer to access information from a single web site in order to view information about home builders, new home communities and their homes that are available from more than one builder.

It is a further object of the current invention for a consumer to define desired parameters in order to locate new home communities and their homes that are available.

It is a further object of the current invention for a consumer to receive information from one or more sellers, which are congruous with the desired parameters.

It is a further object of the current invention for a consumer to set an appointment with one or more sellers whose communities and homes match the desired parameters.

It is a further object of the current invention for a consumer to receive an electronic confirmation of the appointment or appointments made.

### DETAILED DESCRIPTION OF THE PREFERRED EMBODIMENT

The invention is intended to be used by a consumer who is searching information regarding the purchase of a home. A central location on the World Wide Web provides information on various homebuilders and their communities. In providing one centralized location, the provider allows the homebuyer the ease of navigating one consolidated site with information available from many different sites. The specifics of the computer programming language in order to accomplish making this information available are common to one of ordinary skill in the art. This allows the user the ease of looking at one site and eliminates the user from looking at the individual web sites of many different builders. An agent can be the builder, a realtor, or any authorized representative to conduct business for the builder or real estate developer. The user is able to define a set of parameters, which can include; price, location, size of property, size of home, etc. The user can then select a builder and make an appointment with a specific builder at a specific new home community. The user will be contacted electronically to confirm his appointment at the desired new home community or builder's location. The confirming information can include information comprising; date, time, price ranges, home features, and directions to the appointment site.

The method of use of the current invention is as follows: A consumer accesses a single site on the WWW. On this site the consumer selects a number of parameters. The parameters selected can include, but are not limited to, country, state, city, and location within a city, price, property type, lifestyle which is family oriented or active adult, number of bedrooms, number of bathrooms, size of property, inclusion of a pool, and inclusion of a garage. The consumer will then see a display of the various builders that have properties matching the desired parameters. The consumer will then complete a form indicating a preferred date and time to visit the community. The consumer will then receive an electronic confirmation of the appointment. The electronic confirmation can contain information including, but not limited to: name of community and/or builder, date, time, location, prices, and directions. The consumer will receive an electonic reminder shortly before the appointment. Usually, the reminder is one day before the set appointment. The consumer then travels to personally view the selected new home community.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A system for setting appointments from at least one seller comprising:
a) a web-based appointment setter
b) said web-based appointment setter originating from a single web site
c) ability to set one or more appointments from more than one specific seller from a single web site.
d) electronic confirmation of appointment.
e) electronic reminder shortly before scheduled appointment

2. The system of claim 1 wherein the seller is selling new homes.

3. The system of claim 1 wherein the seller is a builder of new homes.

4. The system of claim 1 wherein the seller is a real estate developers' sales representative.

5. The system of claim 1 wherein the seller provides detailed reminder information about a product for sale before the appointment time set by the user.

6. The system of claim 5 wherein said detailed information is the details of a new home community.

7. The system of claim 5 wherein said detailed information comprises;
community and/or builder name, builder representitive name, directions contact phone number, price, size of property, number of bedrooms, and number of bathrooms.

8. A method of using a web based home purchasing system comprising the steps of:
a) accessing a single web site
b) entering parameters desired in a home
c) viewing the web based responses of builders or communities
d) selecting desired builders or communities
e) Setting appointments to personally view one or more communities
f) Receiving electronic confirmation of set appointments
g) Receiving an electronic reminder of set appointments.
